(19) United States
(12) Patent Application Publication
(10) Pub. No.: US 2025/0002109 A1
(43) Pub. Date: Jan. 2, 2025

(54) MEMORY DEVICE FOR HUMAN-POWERED VEHICLE

(71) Applicant: Shimano Inc., Osaka (JP)

(72) Inventors: Hiroshi MATSUDA, Osaka (JP); Toyoto SHIRAI, Osaka (JP); Minoru OMORI, Osaka (JP); Tomohiro KONDO, Osaka (JP)

(21) Appl. No.: 18/659,397

(22) Filed: May 9, 2024

(30) Foreign Application Priority Data
Jun. 29, 2023 (JP) 2023-106929

(51) Int. Cl. B62J 45/20; B62J 50/22

(52) U.S. Cl. CPC B62J 45/20; B62J 50/22

(57) ABSTRACT

A memory device is provided for a human-powered vehicle. The memory device basically includes a base, memory and an electronic controller. The memory is provided on the base. The electronic controller is configured to control the memory so that the memory stores log-related information received from at least one component provided on the human-powered vehicle. The base is arranged in a cavity of a frame of the human-powered vehicle.

### CROSS-REFERENCE TO RELATED APPLICATIONS

This application claims priority to Japanese Patent Application No. 2023-106929, filed on Jun. 29, 2023. The entire disclosure of Japanese Patent Application No. 2023-106929 is hereby incorporated herein by reference.

### BACKGROUND

### Technical Field

The present disclosure generally relates to a memory device for a human-powered vehicle.

### Background Information

Japanese Laid-Open Patent Publication No. 2013-34038 (hereinafter referred to as (Patent Document 1) discloses a human-powered vehicle component provided on a human-powered vehicle. Patent Document 1 discloses a communication adapter capable of connecting a plurality of electrical components through power line communication.

### SUMMARY

An objective of the present disclosure is to provide a memory device for a human-powered vehicle that improves usability.

A memory device in accordance with a first aspect of the present disclosure is for a human-powered vehicle. The memory device comprises a base, memory provided on the base, and an electronic controller. The electronic controller is configured to control the memory so that the memory stores log-related information received from at least one component provided on the human-powered vehicle. The base is configured to be arranged in a cavity of a frame of the human-powered vehicle.

With the memory device according to the first aspect, the memory of the memory device stores the log-related information received from the at least one component provided on the human-powered vehicle. This allows a user to obtain the log-related information from the memory of the memory device. Thus, the memory device improves usability. With the memory device according to the first aspect, the base is arranged in the cavity of the frame. This adequately protects the memory device.

In accordance with a second aspect of the present disclosure, the memory device according to the first aspect is configured so that the base includes an accommodation compartment that accommodates the memory and the electronic controller.

With the memory device according to the second aspect, the memory and the electronic controller are arranged in the accommodation compartment. This adequately protects the memory and the electronic controller.

In accordance with a third aspect of the present disclosure, the memory device according to the first or second aspect further comprises a first communicator configured to perform communication with the at least one component through a first communication line.

The memory device according to the third aspect performs communication with the at least one component through the first communication line.

In accordance with a fourth aspect of the present disclosure, the memory device according to the third aspect further comprises a first communication line connector provided on the base and connected to the first communication line.

The memory device according to the fourth aspect is connected to the at least one component through the first communication line connector.

In accordance with a fifth aspect of the present disclosure, the memory device according to the third or fourth aspect is configured so that the memory device is configured to be supplied with electric power from a battery that is separate from the memory device. The memory device is configured to be supplied with electric power from the battery through the first communication line. The memory device according to the fifth aspect is supplied with electric power from the battery that is separate from the memory device. This reduces the memory device in size.

In accordance with a sixth aspect of the present disclosure, the memory device according to any one of the first to fifth aspects is configured so that the memory device is configured to be supplied with electric power from a battery that is separate from the memory device through a power line. The memory device further comprises a power line connector connected to the power line.

The memory device according to the sixth aspect is supplied with electric power through the power line connector.

In accordance with a seventh aspect of the present disclosure, the memory device according to any one of the first to sixth aspects further comprises a second communicator configured to perform at least one of wired communication and wireless communication with a component that is separate from the memory device. The electronic controller is configured to control the second communicator so that the second communicator transmits the log-related information stored in the memory to the component that is separate from the memory device.

The memory device according to the seventh aspect transmits the log-related information to the separate component. This allows the user to check the log-related information with the separate component.

In accordance with an eighth aspect of the present disclosure, the memory device according to any one of the first to seventh aspects further comprises a display provided on the base.

With the memory device according to the eighth aspect, the user can recognize the information shown on the display.

In accordance with a ninth aspect of the present disclosure, the memory device according to any one of the first to eighth aspects further comprises a first operating portion provided on the base.

With the memory device according to the ninth aspect, the user can operate the first operating portion.

A memory device in accordance with a tenth aspect of the present disclosure is for a human-powered vehicle. The memory device comprises memory, a first communicator, and an electronic controller. The first communicator is configured to perform communication with at least one component provided on the human-powered vehicle through a first communication line. The electronic controller is configured to control the memory so that the memory stores log-related information received from the at least one component. The electronic controller is configured to control a second communicator so that the second communicator transmits the log-related information stored in the memory to a component that is separate from the memory device.

The memory device according to the tenth aspect transmits the log-related information to the separate component. This allows the user to recognize the log-related information with the separate component. Thus, the memory device improves usability.

In accordance with an eleventh aspect of the present disclosure, the memory device according to the tenth aspect is configured so that the second communicator is configured to perform at least one of wired communication and wireless communication with the component that is separate from the memory device.

The memory device according to the eleventh aspect transmits the log-related information to the separate component through at least one of wired communication and wireless communication.

In accordance with a twelfth aspect of the present disclosure, the memory device according to the tenth or eleventh aspect is configured so that the memory device is configured to control the second communicator so that the second communicator transmits the log-related information to the component that is separate from the memory device via a component provided on the human-powered vehicle.

The memory device according to the twelfth aspect transmits the log-related information to the separate component via the component provided on the human-powered vehicle.

A memory device in accordance with a thirteenth aspect of the present disclosure is for a human-powered vehicle. The memory device comprises memory and an electronic controller. The electronic controller is configured to control the memory so that the memory stores log-related information received from at least one component provided on the human-powered vehicle. The memory device excludes an electric actuator and a display.

With the memory device according to the thirteenth aspect, the log-related information is stored in the memory of the memory device, which includes neither an electric actuator nor a display, and which has a simple structure. Thus, the memory device will not interfere with the user riding the human-powered vehicle, thereby improving usability.

A memory device in accordance with a fourteenth aspect of the present disclosure is for a human-powered vehicle. The memory device comprises memory and an electronic controller configured to control the memory. The electronic controller is configured to control the memory so that the memory stores log-related information received from at least one component provided on the human-powered vehicle. The memory device differs from a cycle computer, an assist drive unit, a transmission device, an adjustable seatpost, a suspension, a brake device, a lamp, and a battery unit.

The cycle computer, the assist drive unit, the transmission device, the adjustable seatpost, the suspension, the brake device, the lamp, and the battery unit are frequently used while the human-powered vehicle is traveling. With the memory device according to the fourteenth aspect, the log-related information is stored in a memory device that is not the component frequently used while the human-powered vehicle is traveling. This avoids enlargement of the components that are frequently used while the human-powered vehicle is traveling. Thus, the memory device improves usability.

In accordance with a fifteenth aspect of the present disclosure, the memory device according to any one of the first to fourteenth aspects is configured so that the log-related information includes sensing information obtained from a sensor by the at least one component.

The memory device according to the fifteenth aspect stores the sensing information obtained from the sensor by the at least one component.

In accordance with a sixteenth aspect of the present disclosure, the memory device according to any one of the first to fifteenth aspects further comprises a second operating portion. The electronic controller is configured to control the at least one component so that the at least one component transmits the log-related information to the memory device in a case where the second operating portion is operated.

With the memory device according to the sixteenth aspect, the memory device obtains the log-related information in accordance with operation of the second operating portion.

In accordance with a seventeenth aspect of the present disclosure, the memory device according to any one of the first to sixteenth aspects is configured so that the electronic controller is configured to control the memory so that the memory stores the log-related information upon receipt of the log-related information.

The memory device according to the seventeenth aspect stores log-related information in the memory upon receipt of the log-related information.

In accordance with an eighteenth aspect of the present disclosure, the memory device according to any one of the first to seventeenth aspects is configured so that the electronic controller is configured to control the at least one component so that the at least one component transmits the log-related information to the memory device in a case where the at least one component provided on the human-powered vehicle is operated.

With the memory device according to the eighteenth aspect, the memory device obtains the log-related information in accordance with operation of the at least one component.

In accordance with a nineteenth aspect of the present disclosure, the memory device according to any one of the first to eighteenth aspects is configured so that the electronic controller is configured to control the at least one component so that the at least one component transmits the log-related information to the memory device upon receipt of an acquisition instruction of the log-related information.

The memory device according to the nineteenth aspect obtains the log-related information upon receipt of the acquisition instruction of the log-related information.

In accordance with a twentieth aspect of the present disclosure, the memory device according to any one of the first to nineteenth aspects is configured so that the at least one component includes at least one of a cycle computer, a drive unit, a transmission device, an adjustable seatpost, a suspension, a brake device, a lamp, a battery unit, a transmission operating device, and a power meter.

The memory device according to the twentieth aspect stores in the memory of the memory device the log-related information of at least one of the cycle computer, the drive unit, the transmission device, the adjustable seatpost, the suspension, the brake device, the lamp, the battery unit, the transmission operating device, and the power meter.

The memory device for a human-powered vehicle in accordance with the present disclosure improves usability.

### BRIEF DESCRIPTION OF THE DRAWINGS

Referring now to the attached drawings which form a part of this original disclosure, an illustrative embodiment is shown.

FIG. 1 is a side elevational view of a human-powered vehicle including a human-powered vehicle memory device in accordance with an embodiment.

FIG. 2 is a block diagram showing the electrical configuration of a human-powered vehicle control system including the human-powered vehicle memory device in accordance with the embodiment.

FIG. 3 is a cross-sectional view of the human-powered vehicle memory device shown in FIG. 1.

FIG. 4 is a sequence diagram of processes executed by the human-powered vehicle control system shown in FIG. 2 to collect log-related information.

FIG. 5 is a flowchart illustrating a process executed by a human-powered vehicle controller (an electronic controller) shown in FIG. 2 to transmit log-related information.

FIG. 6 is a cross-sectional view of a human-powered vehicle memory device in accordance with a first modification.

FIG. 7 is a block diagram showing the electrical configuration of a human-powered vehicle control system including the human-powered vehicle memory device of the first modification.

FIG. 8 is a block diagram showing the electrical configuration of a human-powered vehicle memory device in accordance with a second modification.

FIG. 9 is a block diagram showing the electrical configuration of a human-powered vehicle memory device in accordance with a third modification.

FIG. 10 is a flowchart illustrating a process executed by a human-powered vehicle controller (an electronic controller) in accordance with a fourth modification to collect log-related information.

### DETAILED DESCRIPTION

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### Embodiment

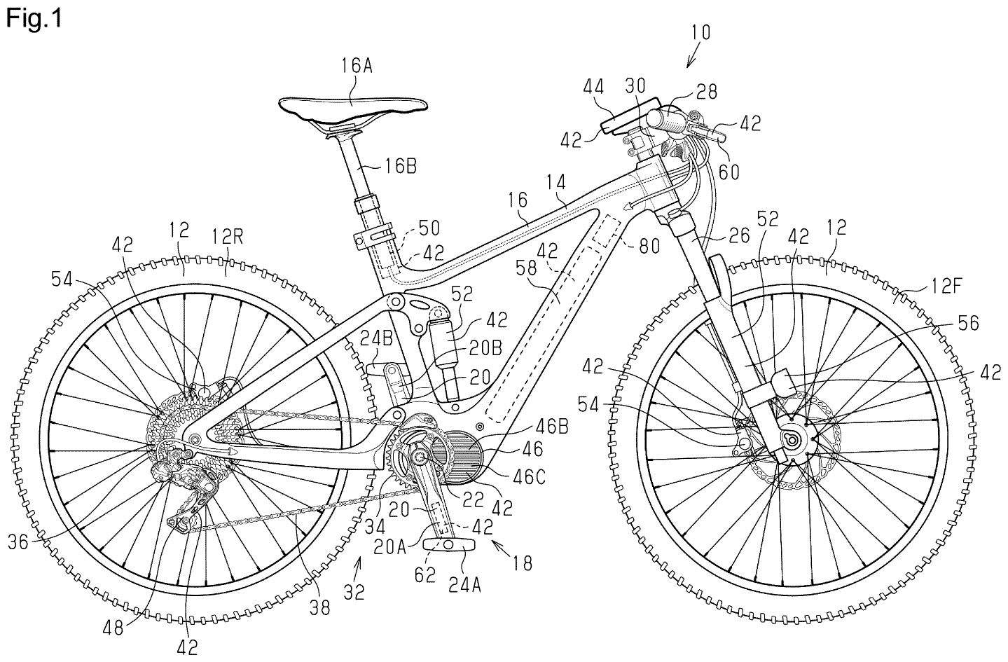

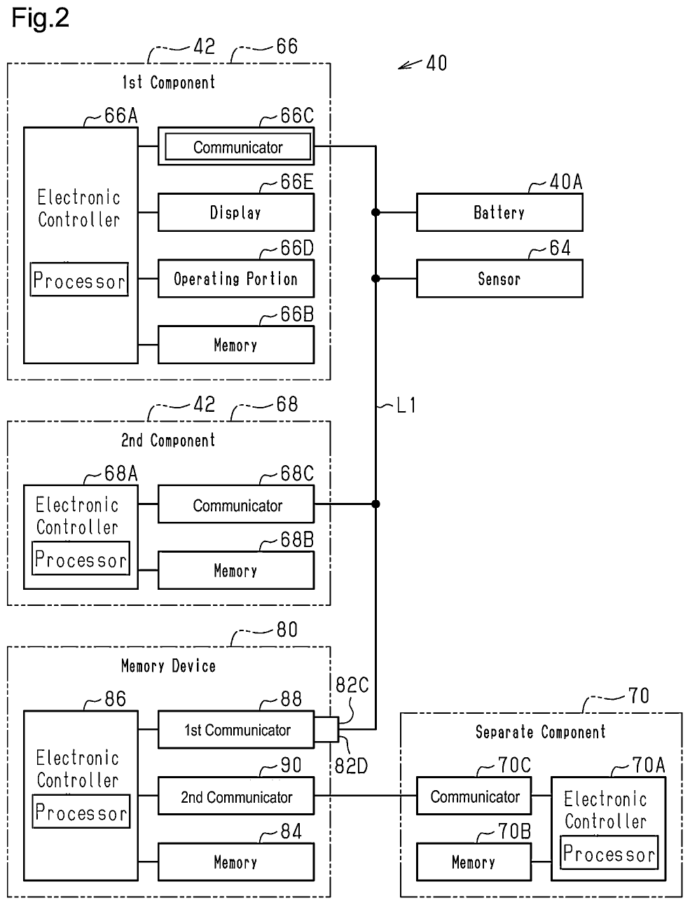

Referring initially to FIGS. 1 and 2, a human-powered vehicle 10 is illustrated in FIG. 1 that is provided with a memory device 80 in accordance with the illustrated embodiments. The memory device 80 of the human-powered vehicle 10 will now be described with reference to FIGS. 1 to 5.

A human-powered vehicle is a vehicle that includes at least one wheel and can be driven by at least a human driving force. Examples of the human-powered vehicle include various types of bicycles such as a mountain bike, a road bike, a city bike, a cargo bike, a handcycle, and a recumbent bike. There is no limit to the number of wheels of the human-powered vehicle. The human-powered vehicle also includes, for example, a unicycle or a vehicle having two or more wheels. The human-powered vehicle is not limited to a vehicle that can be driven only by a human driving force. The human-powered vehicle includes an electric bicycle (E-bike) that uses a drive force of an electric motor for propulsion in addition to the human driving force. The E-bike includes an electric assist bicycle that assists in propulsion with an electric motor. In the embodiment described hereafter, the human-powered vehicle 10 will be described as a bicycle.

As seen in FIG. 1, the human-powered vehicle 10 includes at least one wheel 12 and a vehicle body 14. The at least one wheel 12 includes, for example, a front wheel 12F and a rear wheel 12R. The vehicle body 14 includes a frame 16. For example, a saddle 16A is attached to the frame 16.

The human-powered vehicle 10 further includes, for example, a crank 18 to which human driving force is input. The crank 18 includes, for example, crank arms 20 and a crank axle 22. The crank axle 22 is, for example, rotatable relative to the frame 16. For example, pedals 24A and 24B are coupled to the crank arms 20. The crank arms 20 include, for example, a first crank arm 20A and a second crank arm 20B.

The first crank arm 20A and the second crank arm 20B are, for example, provided on two axial ends of the crank axle 22, respectively. The first pedal 24A is, for example, coupled to the first crank arm 20A. The second pedal 24B is, for example, coupled to the second crank arm 20B.

A front fork 26 is connected to the frame 16. The front wheel 12F is attached to the front fork 26. A handlebar 28 is coupled to the front fork 26 by a stem 30. The rear wheel 12R is supported by the frame 16. In the present embodiment, the crank 18 is connected to the rear wheel 12R by a drive mechanism 32. The rear wheel 12R is driven by the rotation of the crank axle 22. At least one of the front wheel 12F and the rear wheel 12R can be connected to the crank 18 by the drive mechanism 32.

The drive mechanism 32 includes at least one first rotational body 34 coupled to the crank axle 22. The at least one first rotational body 34 includes, for example, a front sprocket. The at least one first rotational body 34 can include a pulley or a bevel gear. The crank axle 22 can be coupled to the front sprocket via a one-way clutch.

The drive mechanism 32 further includes at least one second rotational body 36 and a transferring member 38. The transferring member 38 is configured to transfer the rotational force of the at least one first rotational body 34 to the at least one second rotational body 36. The transferring member 38 includes, for example, a chain. The transferring member 38 can include a belt or a shaft. The at least one second rotational body 36 includes, for example, a rear sprocket. The at least one second rotational body 36 can include a pulley or a bevel gear. The chain is, for example, wound around the front sprocket and the rear sprocket. The at least one second rotational body 36 is, for example, coupled to the rear wheel 12R. The rear wheel 12R is, for example, configured to rotate as the at least one second rotational body 36 rotates.

The human-powered vehicle 10 includes, for example, a human-powered vehicle control system 40. The control system 40 includes at least one component 42 and the memory device 80 configured to perform communication with the at least one component 42. The component 42 is, for example, provided on the human-powered vehicle 10. The component 42 is, for example, configured to be attachable to the vehicle body 14. The component 42 is, for example, used in a state in which the component 42 is coupled to the human-powered vehicle 10.

The at least one component 42 includes, for example, at least one of a cycle computer 44, an assist drive unit 46, a transmission device 48, an adjustable seatpost 50, a suspension 52, a brake device 54, a lamp 56, a battery unit 58, a transmission operating device 60, and a power meter 62. Thus, while only two of the components 42 are diagrammatically illustrated in FIG. 2, the human-powered vehicle control system 40 can have more than two of the components 42 configured to communicate with the memory device 80 as described below.

The cycle computer 44 includes, for example, a display screen. The cycle computer 44 is, for example, provided on the handlebar 28. The cycle computer 44 is, for example, configured to show information related to at least one of a traveling state of the human-powered vehicle 10 and an actuation state of the component 42 on the display screen.

The assist drive unit 46 includes, for example, a motor 46B that applies a propulsion force to the human-powered vehicle 10. The assist drive unit 46 further includes, for example, a housing 46C in which the motor 46B is provided. The assist drive unit 46 is, for example, provided on the crank axle 22. The assist drive unit 46 can be a hub motor provided on the at least one wheel 12.

The transmission device 48 includes a transmission configured to shift a transmission ratio of the human-powered vehicle 10. The transmission device 48 can include an actuator that actuates the transmission. The transmission includes, for example, a derailleur. The derailleur includes, for example, a rear derailleur. The derailleur can include a front derailleur. The derailleur is, for example, provided in a transmission path of human driving force in the human-powered vehicle 10 and configured to shift the transmission ratio. The transmission ratio is, for example, a ratio of rotational speed of the at least one wheel 12 to rotational speed of the crank axle 22. The rotational speed of the at least one wheel 12 includes, for example, rotational speed of the drive wheel. The drive wheel includes, for example, the rear wheel 12R. The drive wheel can include the front wheel 12F. The transmission can include an internal transmission device.

The actuator includes, for example, an electric motor. The actuator is, for example, configured to actuate the derailleur. The transmission device 48 further includes, for example, the at least one second rotational body 36 and the transferring member 38. The at least one second rotational body 36 includes a plurality of second rotational bodies 36. The derailleur shifts the transmission ratio by moving the transferring member 38 from one of the second rotational bodies 36 to another one of the second rotational bodies 36. The relationship of the transmission ratio, the rotational speed of the at least one wheel 12, and the rotational speed of the crank axle 22 satisfies Equation (1). In Equation (1), “R” represents the transmission ratio. In Equation (1), “W” represents the rotational speed of the drive wheel. In Equation (1), “C” represents the rotational speed of the crank axle 22.

$$R = W ( rpm ) / C ( rpm ) \qquad Equation ( 1 )$$

The adjustable seatpost 50 is, for example, attached to a seatpost 16B. The adjustable seatpost 50 raises and lowers the seatpost 16B relative to the frame 16. The adjustable seatpost 50 includes, for example, an electrically-driven actuator or an electrically-driven motor. The adjustable seatpost 50 controls the raising and lowering of the seatpost 16B by actuating the electrically-driven actuator or the electrically-driven motor.

The adjustable seatpost 50 is actuated in accordance with actuation states in which the height of the seatpost 16B differs from one another. The adjustable seatpost 50 switches the actuation state in response to an actuation instruction. In the case of a mechanical seatpost, the adjustable seatpost 50 opens a valve upon receipt of an actuation instruction. In the case of a mechanical seatpost, the adjustable seatpost 50 can be configured to open the valve for a predetermined period upon receipt of an actuation instruction. In the case of a mechanical seatpost, the adjustable seatpost 50 can be configured to open the valve upon receipt of an actuation instruction and keep the valve open until another actuation instruction is received. In the case of an electric seatpost, the adjustable seatpost 50 actuates the electrically-driven actuator or the electrically-driven motor upon receipt of an actuation instruction.

The suspension 52 includes, for example, at least one of a front suspension and a rear suspension. For example, the front suspension is provided on the front fork 26 and reduces impacts applied to the front wheel 12F. For example, the rear suspension is provided on the frame 16 and reduces impacts applied to the rear wheel 12R.

The suspension 52 can be any one of a hydraulic suspension, a pneumatic suspension, and a hybrid suspension using hydraulic pressure. The suspension 52 includes, for example, an electrically-driven actuator or an electrically-driven motor. The suspension 52 includes a valve that opens and closes the flow passage of oil or air.

The suspension 52 is actuated in accordance with a plurality of actuation states. The actuation states include actuation states that differ in at least one of stroke length of the suspension 52, rebound force produced by the suspension 52, and damping force produced by the suspension 52. The suspension 52 is configured to switch the actuation states in response to an actuation instruction. The rebound force produced by the suspension 52 includes, for example, rebound force produced by the suspension 52 in a locked state, rebound force produced by the suspension 52 in an unlocked state, and rebound force produced by the suspension 52 in a semi-locked state.

The brake device 54 brakes the human-powered vehicle 10. The brake device 54 is, for example, provided on at least one of the front wheel 12F and the rear wheel 12R. The brake device 54 can be a hydraulic brake. In a case where the brake device 54 is a hydraulic brake, the brake device 54 includes, for example, an electrically-driven pump.

The lamp 56 includes, for example, a light-emitting diode (LED). The lamp 56 is, for example, coupled to the vehicle body 14 of the human-powered vehicle 10. The lamp 56 is, for example, coupled to at least one of the front fork 26, the handlebar 28, the frame 16, the seatpost 16B, and a luggage carrier attached to the human-powered vehicle 10. The lamp 56 is, for example, coupled to the vehicle body 14 to illuminate the periphery of the human-powered vehicle 10. The lamp 56 can be coupled to the vehicle body 14 to notify nearby vehicles and the like of the presence of the human-powered vehicle 10.

The battery unit 58 includes, for example, one or more battery cells. Each battery cell includes, for example, a rechargeable battery. The battery unit 58 is, for example, provided on the frame 16. The battery unit 58 supplies electric power to, for example, the component 42 that is not the battery unit 58.

The transmission operating device 60 is, for example, provided on the handlebar 28. The transmission operating device 60 includes, for example, a first operation portion for increasing the ratio and a second operation portion for decreasing the ratio.

The power meter 62 is, for example, configured to detect a human driving force applied to the human-powered vehicle 10. The power meter 62 is, for example, provided on at least one of the pedals 24A, 24B, the crank arms 20, and the crank axle 22. The power meter 62 includes, for example, a strain sensor.

The control system 40 can further include, for example, a sensor 64 that transmits sensing data to the component 42. The sensor 64 can be the component 42 included in a communication network. Alternatively, the sensor 64 can be connected to one of the components 42 in a manner allowing for direct communication. The component 42 is, for example, configured to be actuated in accordance with the sensing data obtained from the sensor 64. The sensor 64 can include the power meter 62.

In a case where the control system 40 includes a plurality of components 42, for example, at least one of the components 42 is configured to perform communication with another one of the components 42. Each one of the components 42 is, for example, connected to another component 42 in a manner allowing for communication. Each one of the components 42 is, for example, connected to another component 42 in a manner allowing for wired communication or wireless communication.

Each one of the components 42 is connected to another component 42 through, for example, power line communication (PLC) in a manner allowing for wired communication. Each one of the components 42 can be configured to be connectable to another component 42 in a manner allowing for wired communication by means other than power line communication. Each one of the components 42 can be connected to another component 42 through, for example, Controller Area Network (CAN) or the like.

As illustrated in FIG. 2, the components 42 form, for example, a communication network. The components 42 include, for example, a first component 66 and a second component 68. For example, the first component 66 acts as the master in the communication network, and the second component 68 acts as the slave in the communication network.

The first component 66 includes, for example, an electronic controller 66A. The electronic controller 66A includes, for example, a processor that executes various control programs. The processor includes, for example, a central processing unit (CPU) or a micro-processing unit (MPU). The electronic controller 66A can include one or more microcomputers. The electronic controller 66A can include a plurality of processors located at separate positions. The terms “controller” and “electronic controller” as used herein refer to a hardware device or hardware devices that executes a software program, and does not include a human being.

The first component 66 further includes, for example, memory 66B. The memory 66B stores, for example, various control programs and information used for control processes. The memory 66B includes, for example, at least one of non-volatile storage and volatile storage. The non-volatile storage includes, for example, at least one of a read-only memory (ROM), an erasable programmable read-only memory (EPROM), an electrically erasable programmable read-only memory (EEPROM), and a flash memory. The volatile storage includes, for example, a random-access memory (RAM). The memory 66B can be any computer storage device or any non-transitory computer-readable medium with the sole exception of a transitory, propagating signal.

The memory 66B is configured to store identification information. The identification information is, for example, information that allows the second component 68 to obtain the type of the first component 66. The identification information is, for example, stored in the memory 66B when the first component 66 is shipped out of the factory.

The memory 66B is configured to store log-related information. The log-related information differs in accordance with, for example, the type of the first component 66. The log-related information includes, for example, sensing information obtained from the sensor 64 by the first component 66. The log-related information is related to, for example, at least one of torque based on the human driving force, power based on human driving force, rotational speed of the crank axle 22, traveling speed of the human-powered vehicle 10, acceleration of the human-powered vehicle 10, inclination angle of the human-powered vehicle 10, torque based on assist force of the assist drive unit 46, power based on assist force of the assist drive unit 46, assist mode, transmission ratio of the transmission device 48, transmission operation signal sent from the transmission operating device 60, braking force produced by the brake device 54, operated amount of a brake operating device, height of the seatpost 16B, actuation time of the adjustable seatpost 50, operation signal of an operating device of the adjustable seatpost 50, level of the battery unit 58, internal temperature of the battery unit 58, electric power consumption of the battery unit 58, voltage of the battery unit 58, internal temperature of the first component 66, electric power consumption of at least one of an actuator and a substrate included in the first component 66, voltage in a circuit of at least one of the actuator and the substrate included in the first component 66, and time on a clock included in the first component 66. For example, the electronic controller 66A has the memory 66B accumulate the log-related information until a first condition is satisfied. The first condition is satisfied, for example, in a case where the electronic controller 66A receives a deletion instruction of the log-related information from an external device.

The first component 66 further includes, for example, a communicator 66C. The first component 66 is configured to be connectable to the memory device 80 through at least one of an electric communication cable and a wireless communication device. The communicator 66C can be configured to perform communication with the second component 68. The term “communicator” as used herein refers to hardware and does not include a human being.

The first component 66 further includes, for example, an operating portion 66D. The operating portion 66D includes, for example, at least one of a button and a touch panel.

The first component 66 further includes, for example, a display 66E. The display unit 66E includes, for example, a display panel configured to show an image. The display panel can be a liquid crystal display panel or an organic electro-luminescence (EL) panel. The display unit 66E can include, for example, a speaker. The display 66E is, for example, configured to show various types of information to a user.

The second component 68 includes, for example, an electronic controller 68A. The electronic controller 68A includes, for example, a processor that executes various control programs. The processor includes, for example, a CPU or an MPU. The electronic controller 68A can include one or more microcomputers. The electronic controller 68A can include a plurality of processors located at separate positions.

The second component 68 further includes, for example, memory 68B. The memory 68B stores, for example, various control programs and information used for control processes. The memory 68B includes, for example, at least one of non-volatile storage and volatile storage. The non-volatile storage includes, for example, at least one of a ROM, an EPROM, an EEPROM, and a flash memory. The volatile storage includes, for example, a RAM. The memory 68B can be any computer storage device or any non-transitory computer-readable medium with the sole exception of a transitory, propagating signal.

The memory 68B is configured to store identification information. The identification information is, for example, information that allows the first component 66 to obtain the type of the second component 68. The identification information is, for example, stored in the memory 68B when the second component 68 is shipped out of the factory.

The memory 68B is configured to store log-related information. The log-related information differs in accordance with, for example, the type of the second component 68. The log-related information includes, for example, sensing information obtained from the sensor 64 by the second component 68. The log-related information is related to, for example, at least one of torque based on the human driving force, a power based on the human driving force, a rotational speed of the crank axle 22, a traveling speed of the human-powered vehicle 10, an acceleration of the human-powered vehicle 10, an inclination angle of the human-powered vehicle 10, a torque based on an assist force of the assist drive unit 46, a power based on the assist force of the assist drive unit 46, assist mode, a transmission ratio of the transmission device 48, a transmission operation signal sent from the transmission operating device 60, a braking force produced by the brake device 54, an operated amount of a brake operating device, a height of the seatpost 16B, an actuation time of the adjustable seatpost 50, an operation signal of an operating device of the adjustable seatpost 50, a level of the battery unit 58, an internal temperature of the battery unit 58, an electric power consumption of the battery unit 58, a voltage of the battery unit 58, an internal temperature of the second component 68, an electric power consumption of at least one of an actuator and a substrate included in the second component 68, a voltage in a circuit of at least one of the actuator and the substrate included in the second component 68, and a time on a clock included in the second component 68. For example, the electronic controller 68A has the memory 68B accumulate the log-related information until a second condition is satisfied. The second condition is satisfied, for example, in a case where the electronic controller 68A receives a deletion instruction of the log-related information from an external device.

The second component 68 further includes, for example, a communicator 68C. The second component 68 is configured to be connectable to the memory device 80 through at least one of an electric communication cable and a wireless communication device. The communicator 68C can be configured to perform communication with the first component 66.

The memory device 80 differs from, for example, the cycle computer 44, the assist drive unit 46, the transmission device 48, the adjustable seatpost 50, the suspension 52, the brake device 54, the lamp 56, and the battery unit 58. The memory device 80 differs from, for example, any one of the cycle computer 44, the assist drive unit 46, the transmission device 48, the adjustable seatpost 50, the suspension 52, the brake device 54, the lamp 56, and the battery unit 58. The memory device 80 differs from, for example, an anti-lock braking system (ABS). The memory device 80 differs from, for example, a sensor that detects information related to a traveling state and a traveling environment of the human-powered vehicle 10. For example, the memory device 80 only has the functionalities of data storage and communication. Thus, the memory device 80 is not an integrated part of a cycle computer, an assist drive unit, the transmission device, an adjustable seatpost, a suspension, a brake device, a lamp and a battery unit.

The memory device 80 has, for example, less an electric actuator and a display. In other words, for example, the memory device 80 does not include an electric actuator and/or a display. The memory device 80 does not include, for example, a notification device. The memory device 80 is, for example, formed by a single-piece component. The electric actuator is, for example, at least one of an electric motor and a solenoid. The memory device 80 does not include, for example, a device that performs mechanical movements such as rotation, turning, expansion/contraction, bending/extension, and the like. The display is, for example, at least one of a display and a speaker. The memory device 80 has, for example, less a user interface. In other words, for example, the memory device 80 does not include a user interface.

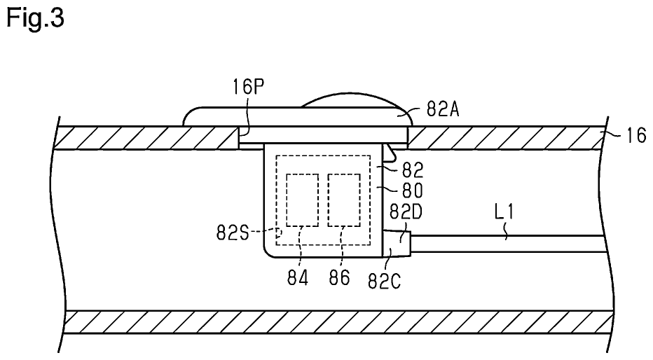

As shown in FIG. 3, the memory device 80 includes a base 82, memory 84, and an electronic controller 86. The base 82 is arranged in a cavity of the frame 16 of the human-powered vehicle 10. The base 82 is, for example, configured to be attachable to the frame 16. The base 82 is, for example, configured to be insertable from an opening 16P of the frame 16 into the cavity of the frame 16. The base 82 can include, for example, a cover 82A that closes the opening 16P. In a case where the opening 16P is closed by the cover 82A, foreign matter and the like will not enter the cavity of the frame 16.

The memory 84 is provided on the base 82. The memory 84 stores information as described below. The memory 84 includes, for example, at least one of non-volatile storage and volatile storage. The non-volatile storage includes, for example, at least one of a ROM, an EPROM, an EEPROM, and a flash memory. The volatile storage includes, for example, a RAM. The memory 84 can be any computer storage device or any non-transitory computer-readable medium with the sole exception of a transitory, propagating signal. The electronic controller 86 is, for example, provided on the base 82. The base 82 includes, for example, an accommodation compartment 82S that accommodates the memory 84 and the electronic controller 86. The base 82 accommodates, for example, the entire memory 84 and the entire electronic controller 86 in the accommodation compartment 82S. The base 82 can accommodate the memory 84 such that the memory 84 is partially outside the accommodation compartment 82S. Further, the base 82 can accommodate the electronic controller 86 such that the electronic controller 86 is partially outside the accommodation compartment 82S.

The memory device 80 further includes, for example, a first communicator 88 configured to perform communication with at least one component 42 through a first communication line L1. In a case where the memory device 80 is configured to be connectable to the component 42 via the first communication line L1, the first communicator 88 is configured to perform communication with the component 42 through, for example, at least one of power line communication (PLC), CAN, and the like. In a case where the memory device 80 is configured to be connectable to the component 42 via a wireless communication device, the first communicator 88 is a wireless communication device configured to perform wireless communication with the component 42. In a case where the memory device 80 is configured to be connectable to the component 42 via a wireless communication device, the first communicator 88 is a wireless communicator configured to perform communication with the component 42 through, for example, at least one of Bluetooth®, Wi-Fi®, infrared communication, and the like.

The memory device 80 further includes, for example, a first communication line connector 82C provided on the base 82 and connected to the first communication line L1. The memory 84 is, for example, configured to be supplied with electric power from a battery 40A that is separate from the memory device 80. The memory 84 is, for example, configured to be supplied with the electric power from the battery 40A through the first communication line L1. In the present embodiment, the battery 40A is, for example, the battery of the battery unit 58.

The memory device 80 is, for example, configured to be supplied with electric power from the battery 40A that is separate from the memory device 80 through a power line. The memory device 80 further includes, for example, a power line connector 82D connected to the power line. In the present embodiment, the first communication line L1 is, for example, an electric line for power line communication (PLC). In the present embodiment, the first communication line connector 82C is formed integrally with the power line connector 82D. For example, the first communication line L1 can be directly connected to the battery unit 58. Alternatively, the first communication line L1 can be connected to the battery unit 58 via at least one component 42.

The memory device 80 forms, for example, a communication network with the component 42. The memory device 80 acts as, for example, the slave in the communication network. In the communication network, the first component 66 acts as, for example, the master of the memory device 80.

The electronic controller 86 is configured to control the memory 84 so that the memory 84 stores log-related information received from the at least one component 42 provided on the human-powered vehicle 10. The log-related information stored in the memory 84 includes, for example, sensing information obtained from the sensor 64 by the at least one component 42. The log-related information stored in the memory 84 can be, for example, all of the log-related information stored in the components 42 or predetermined part of the all log-related information stored in the components 42.

The electronic controller 86 is configured to control the memory 84 so that the memory 84 stores log-related information received from the second component 68. The electronic controller 86 can be configured to control the memory 84 so that the memory 84 stores log-related information received from the first component 66. The electronic controller 86 can be configured to control the memory 84 so that the memory 84 stores log-related information received from the first component 66 and log-related information received from the second component 68.

The electronic controller 86 controls the memory 84 so that the memory 84 stores log-related information, for example, upon receipt of the log-related information. The electronic controller 86 is, for example, configured to store log-related information received from the component 42 in the non-volatile storage of the memory 84. Each time the electronic controller 86 receives log-related information from the component 42, for example, the electronic controller 86 can be configured to store the log-related information in the non-volatile storage of the memory 84 as new data without overwriting the log-related information that is already stored. Each time the electronic controller 86 receives log-related information from the component 42, for example, the electronic controller 86 can be configured to store, as new data, part of the log-related information differing from the log-related information that is already stored in the non-volatile storage of the memory 84.

The electronic controller 86 maintains the log-related information stored in the memory 84, for example, until a predetermined condition is satisfied. The predetermined condition is satisfied, for example, in a case where the electronic controller 86 receives a deletion instruction of the log-related information from an external device. The predetermined condition is satisfied, for example, in a case where the volume of the log-related information stored in the memory 84 becomes greater than or equal to a predetermined volume. In a case where the volume of the log-related information stored in the memory 84 is greater than or equal to the predetermined volume, the electronic controller 86 can delete at least part of the log-related information in the memory 84 and then store the received log-related information in the memory 84.

The electronic controller 66A of the first component 66 is, for example, configured to control at least one component 42 so that the at least one component 42 transmits log-related information to the memory device 80 in a case where an initiation condition is satisfied.

The electronic controller 86 is, for example, configured to control at least one component 42 so that the at least one component 42 transmits log-related information to the memory device 80 in a case where the at least one component 42 provided on the human-powered vehicle 10 is operated. The initiation condition is satisfied, for example, in a case where an operating portion included in the at least one component 42 is operated. The initiation condition is satisfied, for example, in a case where the operating portion 66D of the first component 66 is operated. The initiation condition can be satisfied in a case where an operating portion included in the second component 68 or an operating portion included in a component 70, which is separate from the component 42 and connected to the control system 40, is operated.

The electronic controller 86 can be configured to control at least one component 42 so that the at least one component 42 transmits log-related information to the memory device 80 upon receipt of an acquisition instruction of the log-related information. The at least one component 42 transmits an acquisition instruction, for example, in a case where the at least one component 42 is supplied with electric power. A case where the at least one component 42 is supplied with electric power is, for example, a case where the at least one component 42 is supplied with electric power from the battery 40A. The initiation condition is satisfied, for example, in a case where the electronic controller 86 receives an acquisition instruction of the log-related information.

The initiation condition can be satisfied in a case where the volume of the log-related information stored in the at least one component 42 becomes greater than or equal to an initiation volume. The initiation condition can be satisfied each time a preset period elapses. In a case where the initiation condition is satisfied each time the preset period elapses, the memory device 80 collects log-related information in each preset period.

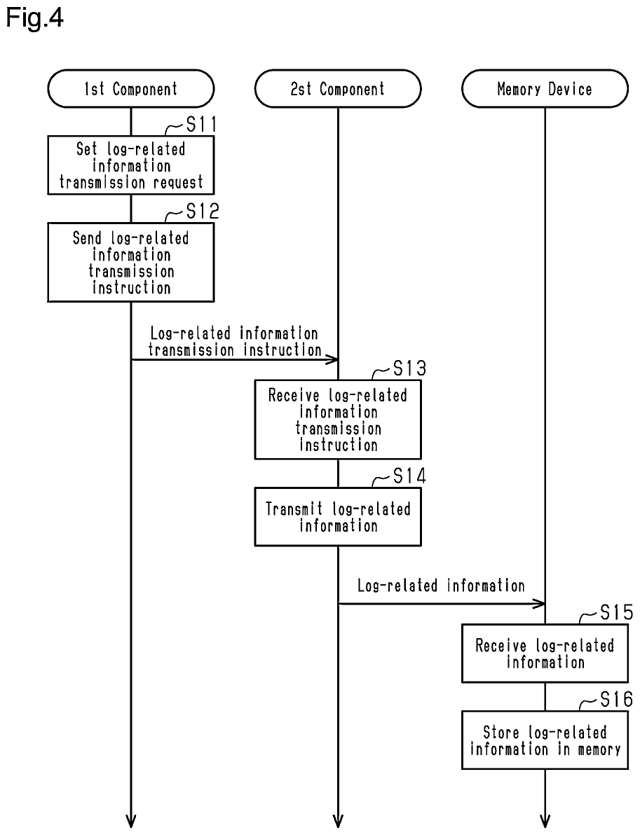

A process executed by the memory device 80 to collect log-related information in the control system 40 will now be described with reference to FIG. 4. The memory device 80 starts collecting log-related information, for example, in a case where the above-described initiation condition is satisfied. In a case where the initiation condition is satisfied, for example, the electronic controller 66A of the first component 66 sets a log-related information transmission request.

In step S11, the electronic controller 66A of the first component 66 sets a log-related information transmission request, and then proceeds to step S12. In step S12, the electronic controller 66A of the first component 66 sends a transmission instruction of the log-related information. For example, the electronic controller 66A of the first component 66 sends the transmission instruction of the log-related information to every second component 68 connected to the first component 66 in a manner allowing for communication, in step S12. For example, the electronic controller 66A of the first component 66 sequentially sends the transmission instruction of the log-related information to a plurality of second components 68 connected to the first component 66 in a manner allowing for communication, in step S12. The electronic controller 66A of the first component 66 can send the transmission instruction of the log-related information to some of the second components 68 connected to the first component 66 in a manner allowing for communication, in step S12.

In step S13, the electronic controller 68A of the second component 68 receives the transmission instruction of the log-related information, and then proceeds to step S14. In step S14, the electronic controller 68A of the second component 68 transmits the log-related information. For example, the electronic controller 68A of the second component 68 transmits the log-related information without specifying a recipient, in step S13. The recipient is specified by, for example, identification information. In a case where the electronic controller 68A of the second component 68 transmits the log-related information without specifying the recipient, for example, the electronic controller 68A of the second component 68 transmits log-related information that does not include identification information specifying the recipient.

The log-related information transmitted without specifying the recipient is sent to every one of the first component 66, the other second components 68, and the memory device 80 included in the communication network. The memory device 80 is configured to obtain the log-related information transmitted without specifying the recipient. The first component 66 is configured to obtain the information transmitted without specifying the recipient from the second component 68. Alternatively, the first component 66 can be configured to ignore the log-related information transmitted without specifying the recipient. The second component 68 is, for example, configured to not obtain the information transmitted without specifying the recipient sent from another second component 68.

In step S15, the electronic controller 86 of the memory device 80 receives the log-related information, and then proceeds to step S16. In step S16, the electronic controller 86 of the memory device 80 stores the received log-related information in the memory 84. In a case where the log-related information is transmitted from a plurality of second components 68 in step S16, for example, the electronic controller 86 of the memory device 80 stores the log-related information for each of the second components 68.

In a case where the electronic controller 66A of the first component 66 sets a log-related information transmission request, the electronic controller 66A of the first component 66 can be configured to transmit the log-related information stored in the memory 66B of the first component 66 to the memory device 80. The memory device 80 stores the log-related information transmitted from the first component 66 in the memory 84 upon receipt of the log-related information from the first component 66.

The memory device 80 further includes, for example, a second communicator 90 configured to perform at least one of wired communication and wireless communication with the component 70 that is separate from the memory device 80. The electronic controller 86 is, for example, configured to control the second communicator 90 so that the second communicator 90 transmits the log-related information stored in the memory 84 to the component 70 that is separate from the memory device 80. The second communicator 90 is, for example, configured to perform at least one of wired communication and wireless communication with the component 70 that is separate from the memory device 80.

The memory device 80 can be configured to control the second communicator 90 so that the second communicator 90 transmits the log-related information to the component 70 that is separate from the memory device 80 via a component 42 provided on the human-powered vehicle 10. For example, the memory device 80 can transmit the log-related information stored in the memory 84 to the first component 66 through power line communication (PLC), and the first component 66 can transmit the log-related information received from the memory device 80 to the separate component 70 through wireless communication.

The separate component 70 is, for example, an external device. The external device includes, for example, at least one of a personal computer, a tablet computer, and a smartphone.

The separate component 70 includes, for example, an electronic controller 70A. The electronic controller 70A includes, for example, a processor that executes various control programs. The processor includes, for example, a CPU or an MPU. The electronic controller 70A can include one or more microcomputers. The electronic controller 70A can include a plurality of processors located at separate positions.

The separate component 70 further includes, for example, memory 70B. The memory 70B stores, for example, various control programs and information used for control processes. The memory 70B includes, for example, at least one of non-volatile storage and volatile storage. The non-volatile storage includes, for example, at least one of a ROM, an EPROM, an EEPROM, and a flash memory. The volatile storage includes, for example, a RAM. The memory 70B can be any computer storage device or any non-transitory computer-readable medium with the sole exception of a transitory, propagating signal.

The memory 70B is configured to store identification information. The identification information is, for example, information that allows the memory device 80 to obtain the type of the separate component 70. The identification information is, for example, stored in the memory 70B when the separate component 70 is shipped out of the factory. The memory 70B is configured to store log-related information of the component 42.

The separate component 70 further includes, for example, a communicator 70C. The separate component 70 is configured to be connectable to the memory device 80 through at least one of an electric communication cable and a wireless communication device. The communicator 70C can be configured to perform communication with the memory device 80 via the first component 66.

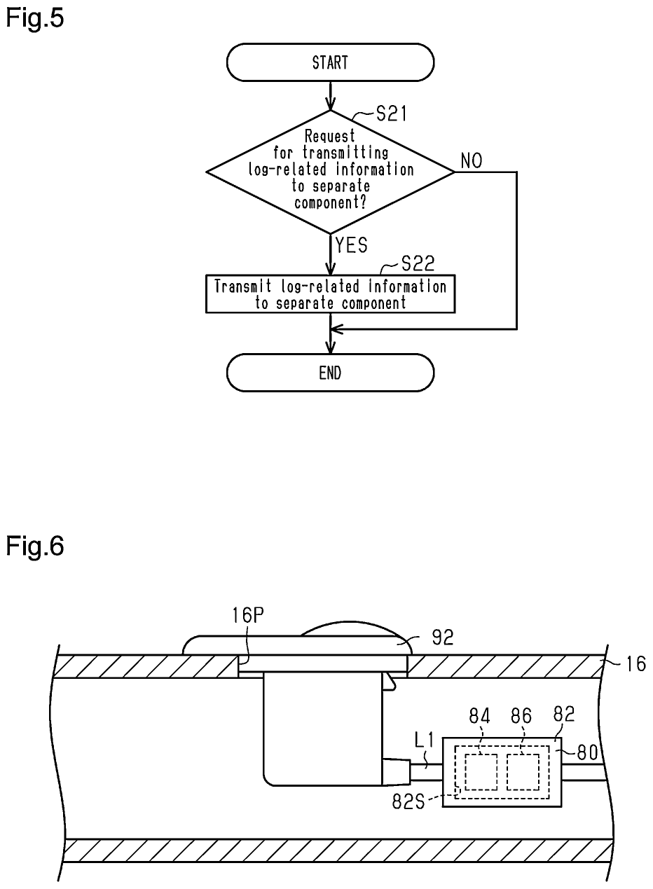

A process executed by the electronic controller 86 of the memory device 80 to transmit log-related information to the separate component 70 will now be described with reference to FIG. 5. In a case where electric power is supplied to the electronic controller 86, for example, the electronic controller 86 starts the process of the flowchart shown in FIG. 5 from step S21. In a case where the process of the flowchart shown in FIG. 5 ends, the electronic controller 86 repeats the process from step S21 in predetermined cycles, for example, until the supply of electric power stops.

In step S21, the electronic controller 86 determines whether there is a request for transmitting log-related information to the separate component 70. The electronic controller 86 determines that there is a request for transmitting log-related information to the separate component 70, for example, in a case where the electronic controller 86 receives a log-related information transmission request from the separate component 70. In a case where there is no request for transmitting log-related information to the separate component 70, the electronic controller 86 ends the process. In a case where there is a request for transmitting log-related information to the separate component 70, the electronic controller 86 proceeds to step S22.

In step S22, the electronic controller 86 transmits log-related information to the separate component 70, and then ends the process. For example, the electronic controller 86 transmits all of the log-related information stored in the memory 84 to the separate component 70, in step S22. The electronic controller 86 can transmit part of the log-related information stored in the memory 84 to the separate component 70, in step S22. The request for transmitting log-related information to the separate component 70 can specify the type of log-related information to be transmitted to the separate component 70.

### Modifications

The description related with the above embodiment exemplifies, without any intention to limit, an applicable form of a memory device for a human-powered vehicle. The memory device for a human-powered vehicle according to the present disclosure is applicable to, for example, modifications of the above embodiment that are described below and combinations of at least two of the modifications that do not contradict each other. In the modifications described hereafter, same reference numerals are given to those components that are the same as the corresponding components of the above embodiment. Such components will not be described in detail.

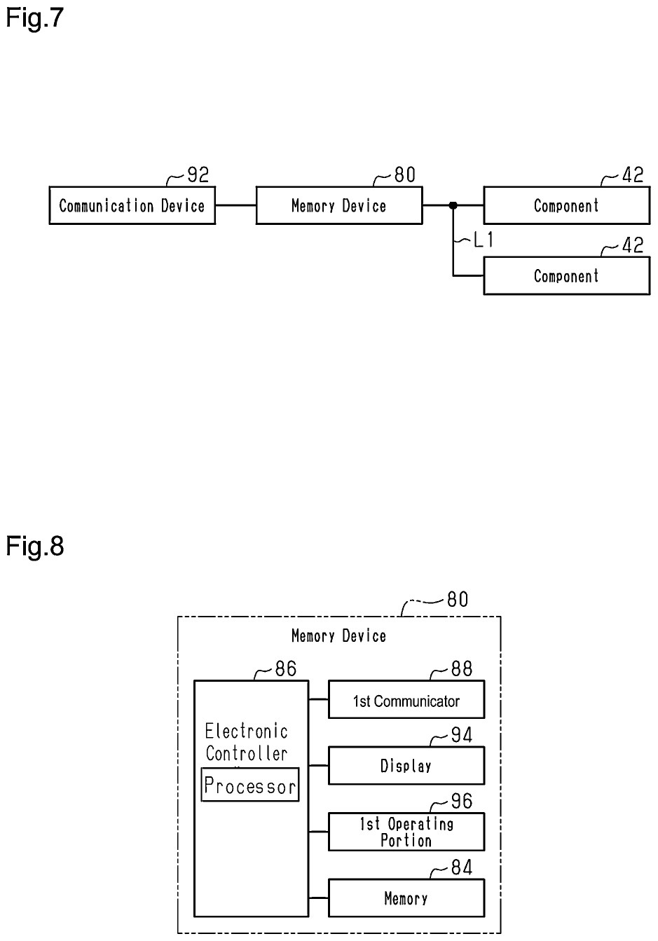

As shown in FIGS. 6 and 7, the control system 40 can include a communication device 92. The term “communication device” as used herein refers to hardware and does not include a human being. The communication device 92 can be a component 42. The communication device 92 includes, for example, a wireless communicator. The wireless communicator of the communication device 92 is, for example, configured to perform wireless communication with the separate component 70. The memory device 80 is, for example, provided in the wiring of the first communication line L1 connecting the communication device 92 and a component 42 that is not the communication device 92. As shown in FIGS. 6 and 7, the communication device 92 can be configured to close the opening 16P of the frame 16, and the entire base 82 of the memory device 80 can be arranged in the cavity of the frame 16.

The base 82 of the memory device 80 can be configured to be attached to the outer surface of the vehicle body 14.

As shown in FIG. 8, the memory device 80 can further include a display 94. The display 94 is, for example, provided on the base 82. The display 94 is, for example, provided on the cover 82A shown in FIG. 3. The display 94 is, for example, provided on the cover 82A such that the display 94 is exposed to the outside from the frame 16 and visually recognizable by a user. The display 94 includes, for example, a light-emitting diode (LED). The display 94 is, for example, illuminated in a case where the memory device 80 is supplied with electric power. The display 94 can include a display configured to show an image and the like.

As shown in FIG. 8, the memory device 80 can further include a first operating portion 96. The first operating portion 96 is, for example, provided on the base 82. The first operating portion 96 is operable by the user. The first operating portion 96 includes, for example, at least one of a keyboard, a mouse, a button, and a touch panel. The first operating portion 96 is, for example, provided on the cover 82A shown in FIG. 3. The first operating portion 96 is, for example, provided on the cover 82A such that the first operating portion 96 is exposed to the outside from the frame 16 and operable by the user. In a case where the memory device 80 includes the first operating portion 96, the initiation condition for the memory device 80 to initiate collection of log-related information can be satisfied, for example, in a case where the first operating portion 96 is operated.

The electronic controller 66A of the first component 66 can be configured to aggregate the log-related information received from the second component 68 and transmit the log-related information to the memory device 80.

The communication network does not have to have specified master and slave. In the present modification, for example, any of the electronic controller 86 of the memory device 80 and the at least one component 42 can send a transmission instruction of the log-related information.

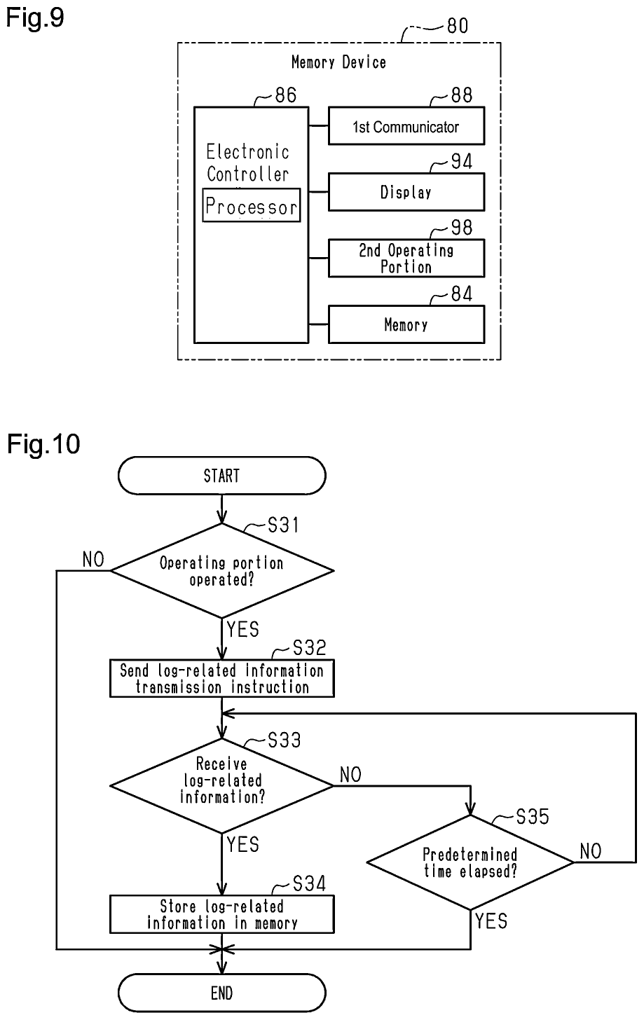

The transmission instruction of the log-related information can be sent in accordance with operation of a second operating portion 98 shown in FIG. 9. The memory device 80 further includes, for example, the second operating portion 98. In a case where the second operating portion 98 is operated, the electronic controller 86 is configured to control the at least one component 42 so that the at least one component 42 transmits log-related information to the memory device 80.

A process executed by the electronic controller 86 of the memory device 80 to collect log-related information will now be described with reference to FIG. 10. In a case where electric power is supplied to the electronic controller 86, for example, the electronic controller 86 starts the process of the flowchart shown in FIG. 10 from step S31. In a case where the process of the flowchart shown in FIG. 10 ends, the electronic controller 86 repeats the process from step S31 in predetermined cycles, for example, until the supply of electric power stops.

In step S31, the electronic controller 86 determines whether the second operating portion 98 is operated. In a case where the second operating portion 98 is not operated, the electronic controller 86 ends the process. In a case where the first operating portion 96 is operated, the electronic controller 86 proceeds to step S32. In step S32, the electronic controller 86 sends a transmission instruction of the log-related information, and then proceeds to step S33.

In step S33, the electronic controller 86 determines whether the electronic controller 86 receives log-related information. In a case where the electronic controller 86 receives log-related information, the electronic controller 86 proceeds to step S34. In step S34, the electronic controller 86 stores the log-related information in the memory 84, and then ends the process.

In a case where log-related information is not received in step S33, the electronic controller 86 proceeds to step S35. In step S35, the electronic controller 86 determines whether a predetermined time has elapsed. The predetermined time is set to, for example, a period of time sufficient for receiving log-related information from when a transmission instruction of the log-related information is transmitted. In a case where the predetermined time has not elapsed, the electronic controller 86 proceeds to step S33. In a case where the predetermined time has elapsed, the electronic controller 86 ends the process.

The memory device 80 can be configured to store the log-related information, stored in memory of another component that is not included in the communication network, to the memory 84. For example, at least one component 42 is connected to the other component in a manner allowing for communication. The log-related information stored in the memory of the other component is, for example, transmitted to the memory device 80 via the at least one component 42. The other component includes, for example, a global positioning system (GPS) receiver. The log-related information of the GPS receiver includes, for example, time.

In a case where the log-related information includes time, at least one of the electronic controller 86 and the electronic controller 70A of the separate component 70 can be configured to generate combined information combining the log-related information obtained from each component 42 based on the time.

As long as the memory device 80 is configured as described below, other configurations can be changed. The memory device 80 includes the memory 84 and the electronic controller 86 configured to control the memory 84. The electronic controller 86 is configured to control the memory 84 so that the memory 84 stores the log-related information received from the at least one component 42 provided on the human-powered vehicle 10. The memory device 80 differs from the cycle computer 44, the assist drive unit 46, the transmission device 48, the adjustable seatpost 50, the suspension 52, the brake device 54, the lamp 56, and the battery unit 58.

As long as the memory device 80 is configured as described below, other configurations can be changed. The memory device 80 includes the memory 84 and the electronic controller 86 configured to control the memory 84 so that the memory 84 stores the log-related information received from the at least one component 42 provided on the human-powered vehicle 10. The memory device 80 excludes an electric actuator and a display. In other words, the memory device 80 does not include either an electric actuator or a display.

As long as the memory device 80 is configured as described below, other configurations can be changed. The memory device 80 includes the memory 84, the first communicator 88, and the electronic controller 86. The first communicator 88 is configured to perform communication with the at least one component 42 provided on the human-powered vehicle 10 through the first communication line L1. The electronic controller 86 is configured to control the memory 84 so that the memory 84 stores the log-related information received from the at least one component 42. The electronic controller 86 is configured to control the second communicator 90 so that the second communicator 90 transmits the log-related information stored in the memory 84 to the component 70 that is separate from the memory device 80. In the present modification, the second communicator 90 can be arranged on a predetermined component that differs from the memory device 80. The predetermined component is, for example, separate from the memory device 80. The predetermined component is, for example, a component provided on the human-powered vehicle 10. The predetermined component can be the communication device 92 shown in FIGS. 6 and 7. The predetermined component can be the component 42. The present modification is, for example, configured so that the log-related information is transmitted to the separate component 70 via the second communicator 90 arranged on the component that differs from the memory device 80.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of two or more choices” if the number of its choices three or more.

Ordinal numerals such as “first”, “second”, and “third” as used in this specification are only to differentiate multiple members having the same name and these words have no special meaning.

What is claimed is:

1. A memory device for a human-powered vehicle, the memory device comprising:
a base;
memory provided on the base; and
an electronic controller configured to control the memory so that the memory stores log-related information received from at least one component provided on the human-powered vehicle;
the base being configured to be arranged in a cavity of a frame of the human-powered vehicle.

2. The memory device according to claim 1, wherein
the base includes an accommodation compartment that accommodates the memory and the electronic controller.

3. The memory device according to claim 1, further comprising:
a first communicator configured to perform communication with the at least one component through a first communication line.

4. The memory device according to claim 3, further comprising:
a first communication line connector provided on the base and connected to the first communication line.

5. The memory device according to claim 3, wherein:
the memory device is configured to be supplied with electric power from a battery that is separate from the memory device; and
the memory device is configured to be supplied with electric power from the battery through the first communication line.

6. The memory device according to claim 1, wherein
the memory device is configured to be supplied with electric power from a battery that is separate from the memory device through a power line, the memory device further comprising:
a power line connector connected to the power line.

7. The memory device according to claim 1, further comprising:
a second communicator configured to perform at least one of wired communication and wireless communication with a component that is separate from the memory device;
the electronic controller being configured to control the second communicator so that the second communicator transmits the log-related information stored in the memory to the component that is separate from the memory device.

8. The memory device according to claim 1, further comprising:
a display provided on the base.

9. The memory device according to claim 1, further comprising:
a first operating portion provided on the base.

10. A memory device for a human-powered vehicle, the memory device comprising:
memory;
a first communicator configured to perform communication with at least one component provided on the human-powered vehicle through a first communication line; and
an electronic controller configured to control the memory so that the memory stores log-related information received from the at least one component;
the electronic controller being configured to control a second communicator so that the second communicator transmits the log-related information stored in the memory to a component that is separate from the memory device.

11. The memory device according to claim 10, wherein
the second communicator is configured to perform at least one of wired communication and wireless communication with the component that is separate from the memory device.

12. The memory device according to claim 10, wherein
the memory device is configured to control the second communicator so that the second communicator transmits the log-related information to the component that is separate from the memory device via a component provided on the human-powered vehicle.

13. A memory device for a human-powered vehicle, the memory device comprising:
memory; and
an electronic controller configured to control the memory so that the memory stores log-related information received from at least one component provided on the human-powered vehicle;
the memory device excluding an electric actuator and a display.

14. A memory device for a human-powered vehicle, the memory device comprising:
memory; and
an electronic controller configured to control the memory;
the electronic controller being configured to control the memory so that the memory stores log-related information received from at least one component provided on the human-powered vehicle; and
the memory device differing from a cycle computer, an assist drive unit, a transmission device, an adjustable seatpost, a suspension, a brake device, a lamp, and a battery unit.

15. The memory device according to claim 1, wherein
the log-related information includes sensing information obtained from a sensor by the at least one component.

16. The memory device according to claim 1, further comprising:
a second operating portion;
the electronic controller being configured to control the at least one component so that the at least one component transmits the log-related information to the memory device in a case where the second operating portion is operated.

17. The memory device according to claim 1, wherein
the electronic controller is configured to control the memory so that the memory stores the log-related information upon receipt of the log-related information.

18. The memory device according to claim 1, wherein
the electronic controller is configured to control the at least one component so that the at least one component transmits the log-related information to the memory device in a case where the at least one component provided on the human-powered vehicle is operated.

19. The memory device according to claim 1, wherein
the electronic controller is configured to control the at least one component so that the at least one component transmits the log-related information to the memory device upon receipt of an acquisition instruction of the log-related information.

20. The memory device according to claim 1, wherein
the at least one component includes at least one of a cycle computer, a drive unit, a transmission device, an adjustable seatpost, a suspension, a brake device, a lamp, a battery unit, a transmission operating device, and a power meter.
